(19) United States
(12) Patent Application Publication
(10) Pub. No.: US 2007/0005156 A1
(43) Pub. Date: Jan. 4, 2007

(54) Method and apparatus for supporting multiple vision systems

(75) Inventors: Bahram Moinvaziri, Phoenix, AZ (US); Kirk E. Griffin, Gilbert, AZ (US)

Correspondence Address: LAWRENCE CHO;C/O PORTFOLIOIP, P. O. BOX 52050, MINNEAPOLIS, MN, 55402, US

(73) Assignee: Intel Corporation

(21) Appl. No.: 11/169,392

(22) Filed: Jun. 29, 2005

(51) Int. Cl. G05B 19/18

(52) U.S. Cl. 700/56

(57) ABSTRACT

A method for managing a multiple vision system includes identifying a plurality of smart cameras to group in a cluster. A first map is generated from data received from the smart cameras in the cluster. Other embodiments are described and claimed.

### FIELD

Embodiments of the present invention relate to multiple vision systems. More specifically, embodiments of the present invention relate to methods and apparatus for managing smart cameras in multiple vision systems.

### BACKGROUND

Multiple vision systems play an important role in product manufacturing. Many manufacturing facilities utilize multiple vision systems to locate and position work, track the flow of components, and inspect output for quality and consistency. Cameras positioned on the production line capture images of components inspected and transmit the images to a computer system. The computer system may then perform image analysis to generate decisions about the image. Some decisions may include the location of the component at the facility, whether the component is in good condition, the identity of the component, and measurements of the component.

Some multiple vision systems have begun utilizing smart cameras. A smart camera is an intelligent camera that includes a dedicated processor, memory, and sensors. With these components, a smart camera has the capability to perform imaging, image processing, and decision making functions. Smart cameras may generate data that may be utilized by a multiple vision system to assist in locating and positioning, tracking, and inspecting output.

When more than one smart camera is utilized in a multiple vision system, multiple instances of a single camera interface are required during a run time to support the smart cameras. Executing multiple instances of the single camera interface consumes additional memory in the computer system managing the multiple vision system. This could adversely affect the performance of other programs executed on the computer system which is commonly used to also operate as a station controller for managing other functions on the production line.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 illustrates an embodiment of a computer system in which an example embodiment of the present invention resides.

FIG. 2 is a block diagram of a station controller unit according to an example embodiment of the present invention.

FIG. 3 is a block diagram of a multi-camera interface server unit according to an example embodiment of the present invention.

FIG. 4 is a block diagram of a multi-camera interface service core logic module according to an example embodiment of the present invention.

FIG. 5 is a flow chart that illustrates a method for managing a multiple vision system according to an example embodiment of the present invention.

### DETAILED DESCRIPTION

In the following description, for purposes of explanation, specific nomenclature is set forth to provide a thorough understanding of embodiments of the present invention. It will be apparent to one skilled in the art that specific details in the description may not be required to practice the embodiments of the present invention. In other instances, well-known circuits, devices, and programs are shown in block diagram form to avoid obscuring embodiments of the present invention unnecessarily.

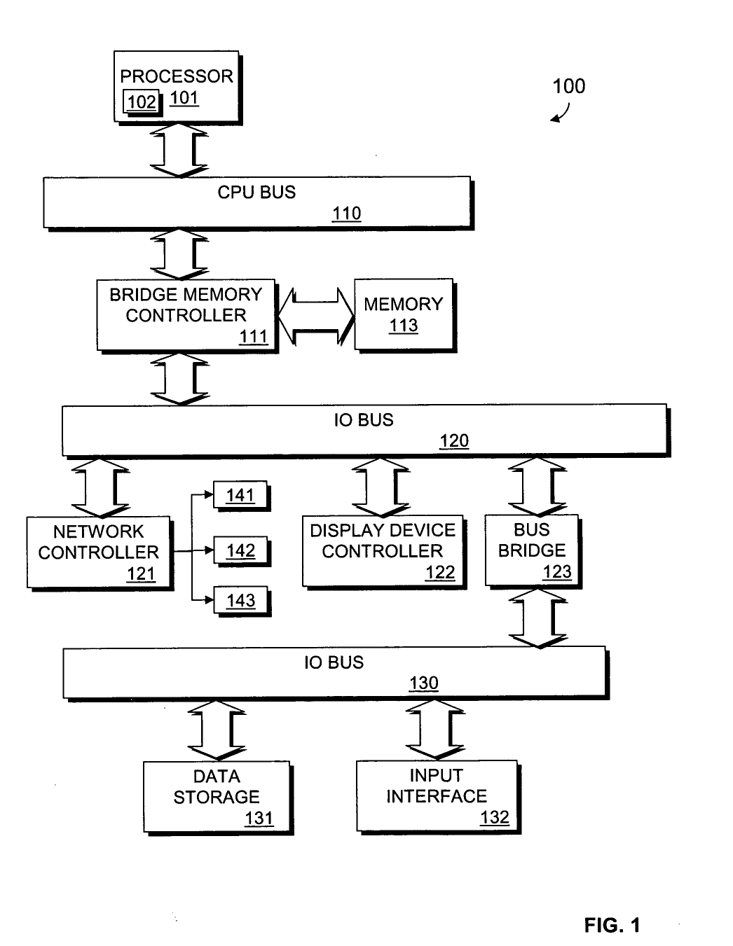

FIG. 1 is a block diagram of an exemplary computer system 100 according to an embodiment of the present invention. The computer system 100 includes a processor 101 that processes data signals. The processor 101 may be a complex instruction set computer microprocessor, a reduced instruction set computing microprocessor, a very long instruction word microprocessor, a processor implementing a combination of instruction sets, or other processor device. FIG. 1 shows the computer system 100 with a single processor. However, it is understood that the computer system 100 may operate with multiple processors. Additionally, each of the one or more processors may support one or more hardware threads. The processor 101 is coupled to a CPU bus 110 that transmits data signals between processor 101 and other components in the computer system 100.

The computer system 100 includes a memory 113. The memory 113 may be a dynamic random access memory device, a static random access memory device, read-only memory, and/or other memory device. The memory 113 may store instructions and code represented by data signals that may be executed by the processor 101. A cache memory 102 may reside inside processor 101 that stores data signals stored in memory 113. The cache 102 speeds access to memory by the processor 101 by taking advantage of its locality of access. In an alternate embodiment of the computer system 100, the cache resides external to the processor 101.

A bridge memory controller 111 is coupled to the CPU bus 110 and the memory 113. The bridge memory controller 111 directs data signals between the processor 101, the memory 113, and other components in the computer system 100 and bridges the data signals between the CPU bus 110, the memory 113, and input output (IO) bus 120.

The IO bus 120 may be a single bus or a combination of multiple buses. The IO bus 120 provides communication links between components in the computer system 100. A network controller 121 is coupled to the IO bus 120. The network controller 121 may link the computer system 100 to a network of computers (not shown) and supports communication among the machines. The network controller 121 may also link the computer system 100 to one or more other devices. According to an embodiment of the computer system 100, the network controller 121 provides an Ethernet connection to allow a plurality of smart cameras 141-143 to be connected to the computer system 100. A display device controller 122 is coupled to the IO bus 120. The display device controller 122 allows coupling of a display device (not shown) to the computer system 100 and acts as an interface between the display device and the computer system 100.

IO bus 130 may be a single bus or a combination of multiple buses. IO bus 130 provides communication links between components in the computer system 100. A data storage device 131 is coupled to the IO bus 130. The data storage device 131 may be a hard disk drive, a floppy disk drive, a CD-ROM device, a flash memory device or other mass storage device. An input interface 132 is coupled to the IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. A bus bridge 123 couples IO bus 120 to IO bus 130. The bus bridge 123 operates to buffer and bridge data signals between IO bus 120 and IO bus 130.

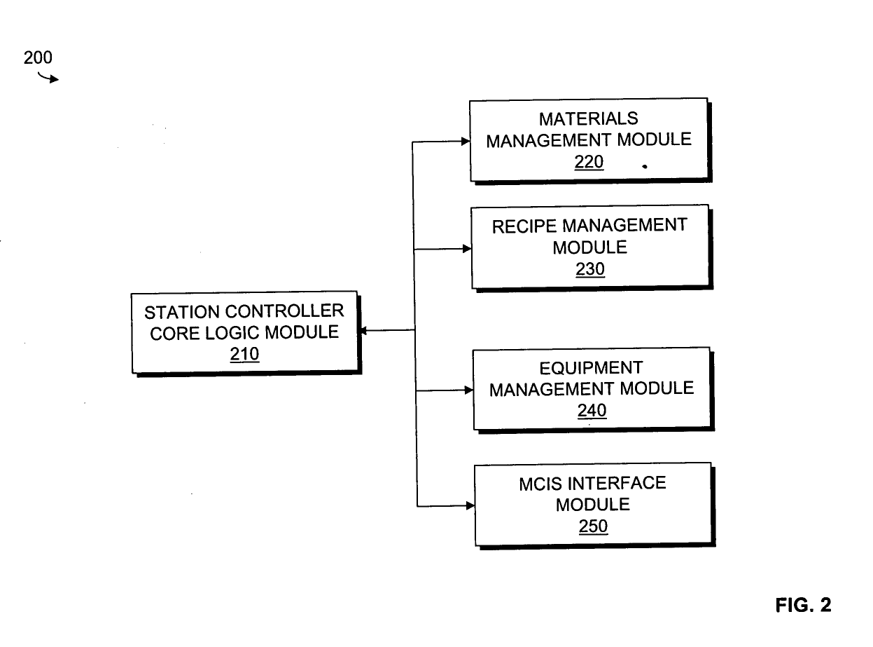

FIG. 2 is a block diagram of a station controller unit 200 according to an example embodiment of the present invention. The station controller unit 200 may be implemented by a computer system such as the computer system 100 shown in FIG. 1. According to an embodiment of the present invention, the station controller unit 200 may be implemented with a plurality of software modules. Alternatively, the station controller unit 200 may be implemented with hardware or a combination of hardware and software. According to an embodiment of the present invention, the station controller unit 200 is an agent that manages a manufacturing process. The station controller unit 200 includes a station controller core logic module 210. The station controller core logic module 210 manages components of the station controller unit 200 and transmits information between the components of the station controller unit 200.

The station controller unit 200 includes a material management module 220. The material management module 220 tracks the materials used in the manufacturing process. According to an embodiment of the station controller unit 200, the material management module 220 may confirm the identity, quantity, location and/or condition of materials available by analyzing information about the materials received by the station controller core logic module 210.

The station controller unit 200 includes a recipe management module 230. The recipe management module 230 coordinates the transmission of appropriate procedures to be performed by equipment used by the manufacturing process. According to an embodiment of the station controller unit 200, the recipe management module 230 may confirm that the appropriate procedures are performed on the material by analyzing information received by the station controller core logic module 210.

The station controller unit 200 includes an equipment management module 240. The equipment management module 240 manages the operation of equipment in the manufacturing process. According to an embodiment of the station controller unit 200, the equipment management module 240 may confirm the operational status of each piece of equipment and its interaction with materials in the manufacturing process by analyzing information received by the station controller core logic module 210.

The station controller unit 200 includes a multi-camera interface server (MCIS) interface module 250. The MCIS interface module 250 interfaces with a MCIS unit. According to an embodiment of the station controller unit 200, the MCIS interface module 250 communicates with and receives information from the MCIS unit that allows the components on the station controller unit 200 to manage materials, procedures, and equipment in the manufacturing process. The information received by the MCIS interface module 250 may include a map generated by the MCIS unit. The map may include data taken from a plurality of devices such as smart cameras positioned to observe the manufacturing process. In addition to having the material management module 220, recipe management module 230, and/or equipment management module 240 analyze maps generated by the MCIS unit, the station controller core logic unit 210 may also analyze maps generated at various points in the manufacturing process with respect to one another to observe changes.

It should be appreciated that the station controller core logic unit 210, material management module 220, recipe management module 230, equipment management module 240, and the MCIS interface module 250 may be implemented using any appropriate procedure, technique, or circuitry.

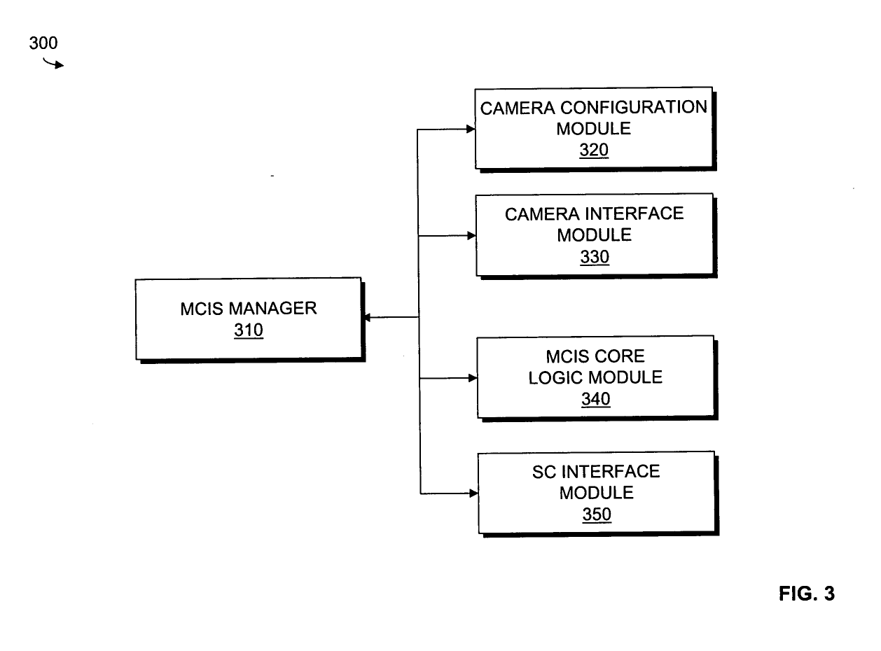

FIG. 3 is a block diagram of a MCIS unit 300 according to an example embodiment of the present invention. The MCIS unit 300 may be implemented by a computer system such as the computer system 100 shown in FIG. 1. According to an embodiment of the present invention, the MCIS unit 300 may be implemented with a plurality of software modules. Alternatively, the MCIS unit 300 may be implemented with hardware or a combination of hardware and software. According to an embodiment of the present invention, the MCIS unit 300 is an agent that manages smart cameras in a multiple vision system. The MCIS unit 300 includes a MCIS manager 310. The MCIS manager 310 manages and transmits information between components in the MCIS unit 300.

The MCIS unit 300 includes a camera configuration module 320. The camera configuration module 320 controls the smart cameras in the multiple vision system. For example, the camera configuration module 320 may program settings on the smart cameras and/or the physical positioning of the smart cameras. According to an embodiment of the MCIS unit 300, the camera configuration module 320 may assign a camera identifier to each smart camera in the multiple vision system. The camera identifier may include, for example, a media access control (MAC) identifier, Internet Protocol (IP) address, an equipment name, and/or other identifiers. The camera identifier may be used by components in the MCIS unit 300 to reference a smart camera, instructions provided to a smart camera, and/or data generated by a smart camera. The camera configuration module 320 may also identify or allow a user to identify a plurality of smart cameras to group in a cluster. The smart cameras may be grouped together based upon a location the smart cameras are situated, a specific procedure the smart cameras are observing, a component or sub-component the smart cameras are monitoring, or other criteria.

The MCIS unit 300 includes a camera interface module 330. The camera interface module 330 interfaces with the smart cameras in the multiple vision system and provides support in communicating with the smart cameras. According to an embodiment of the MCIS unit 300, the camera interface module 330 operates as a device driver for the smart cameras. According to an embodiment of the present invention, the camera interface manager 330 may utilize the camera identifiers assigned by the camera configuration module 320 when referencing a smart camera. This would allow a single instance of the camera interface module 330 to support a plurality of smart cameras. Data generated by the smart cameras in the multiple vision system are forwarded to the MCIS unit 300 via the camera interface module 330.

The MCIS unit 300 includes a MCIS core logic module 340. The MCIS core logic module 340 processes the data generated by the smart cameras. According to an embodiment of the MCIS unit 300, the MCIS core logic module 340 analyzes the data generated by the smart camera for errors. The MCIS core logic module 340 may also generate maps of clusters for analysis by the MCIS core logic module 340, a station controller unit, or a user.

The MCIS unit 300 includes a station controller (SC) interface module 350. The station controller interface module 350 communicates with a station controller unit. According to an embodiment of the MCIS unit 300, the station controller interface module 350 may forward data, such as maps of clusters, notification of errors, and other information to the station controller unit.

It should be appreciated that the MCIS manager 310, camera configuration module 320, camera interface module 330, MCIS core logic module 340, and station controller interface module 350 may be implemented using any appropriate procedure, technique, or circuitry. It should further be appreciated that the MCIS manager 310 may include other modules or components to perform other procedures or tasks.

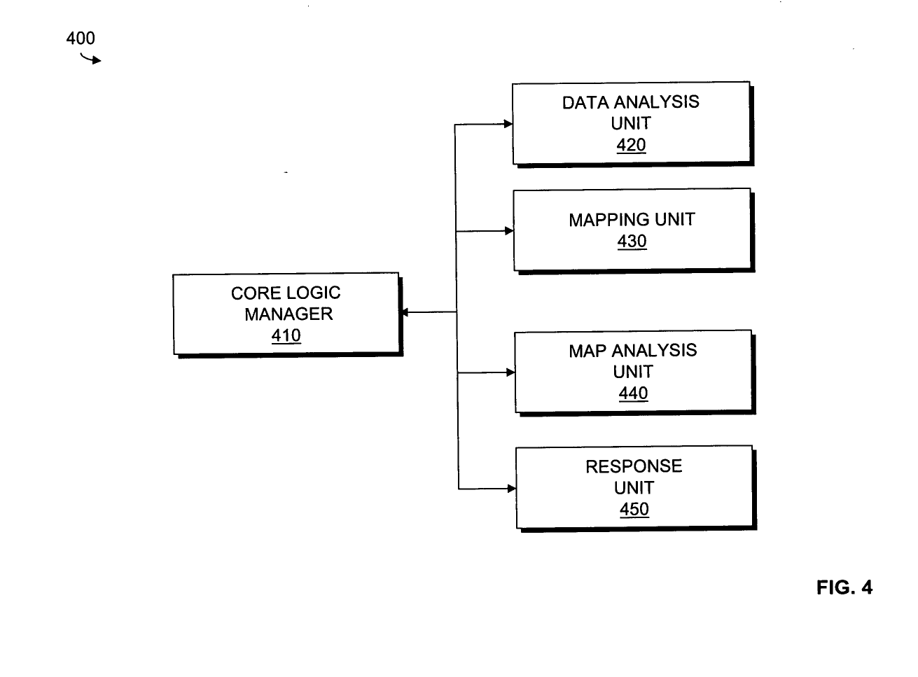

FIG. 4 is a block diagram of a MCIS core logic module 400 according to an example embodiment of the present invention. The MCIS core logic module 400 may be implemented as the MCIS core logic module 340 shown in FIG. 3. The MCIS core logic module 400 includes a core logic manager 410. The core logic manager 410 interfaces with and transmits information between components in the MCIS core logic module 400.

The MCIS core logic module 400 includes a data analysis unit 420. The data analysis unit 410 analyzes data generated by one or more smart cameras in the multiple vision system. According to an embodiment of the MCIS core logic module 400, the data analysis unit 410 may apply a set of predefined rules to analyze the data to determine whether a smart camera is functioning properly or positioned correctly. It should be appreciated that the rules may be generated by the MCIS core logic module 400 or provided by a user.

The MCIS core logic module 400 includes a mapping unit 430. The mapping unit 430 generates a map of a cluster. According to an embodiment of the MCIS core logic module 400, the mapping unit 430 retrieves data generated from smart cameras associated with a cluster and combines the data to form a map. A map may include image data, text data, a combination of image and text data, and/or other type of data generated by the smart cameras in the multiple vision system and/or other components in the MCIS core logic module 400. A map may include, for example, an identifier for a carrier of a component being manufactured by the manufacture process, and a component identifier, such as a substrate identifier.

The MCIS core logic module 400 includes a map analysis unit 440. The map analysis unit 440 analyzes the maps generated by the mapping unit 430. According to an embodiment of the MCIS core logic unit 400, the map analysis unit 440 may apply one or more policies to analyze a map. For example, policies may be provided by a user for the map analysis unit 440 to check properties of the data in a map to determine whether a component has been manufactured properly.

The MCS core logic module 400 includes a response unit 450. The response unit 450 generates an appropriate response to analysis performed by the data analysis unit 420 and the map analysis unit 440. According to an embodiment of the MCIS core logic module 400, the response unit 450 may initiate a modification to a smart camera. The response unit 450 may also generate a notification of an error or problem, a status report, or other response.

The core logic manager 410, data analysis unit 420, mapping unit 430, map analysis unit 440, and response unit 450 may be implemented using any known procedure, technique, or circuitry. It should be appreciated that not all of the components illustrated are required to practice an embodiment of the present invention.

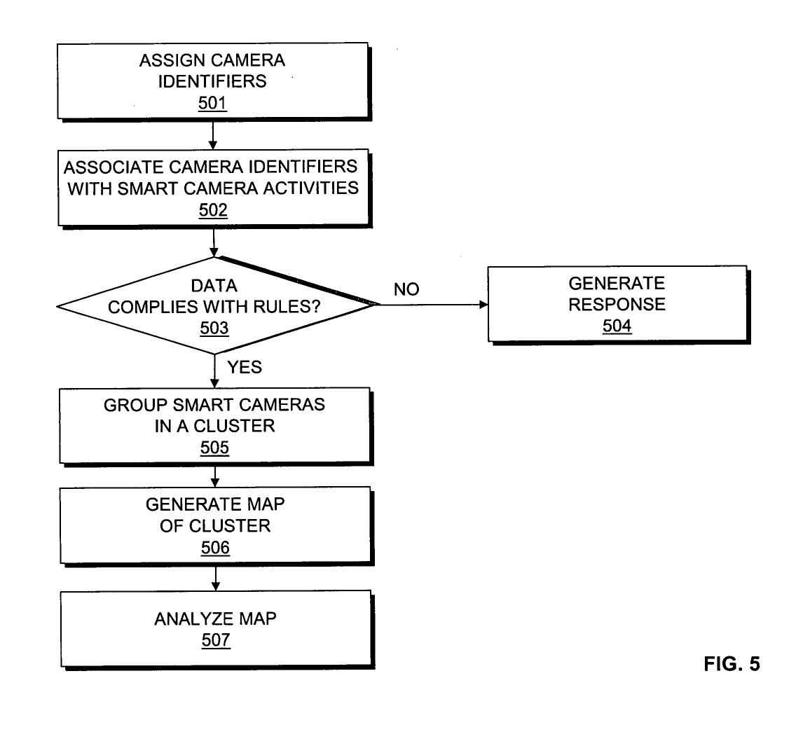

FIG. 5 is a flow chart that illustrates a method for managing a multi-vision system according to an example embodiment of the present invention. At 501, camera identifiers are assigned to smart cameras in a multiple vision system. The camera identifiers may include a MAC address, and IP address, an equipment name, or other identifiers.

At 502, the camera identifiers are associated with activities performed by the smart cameras. According to an embodiment of the present invention, the camera identifiers are utilized to reference the smart cameras, instructions directed to the smart cameras, and/or data generated from the smart cameras to allow a single instance of a camera interface module to be used to support a plurality of smart cameras.

At 503, it is determined whether the data from the smart cameras complies with predefined rules. According to an embodiment of the present invention, the predefined rules may pertain to quantities, measurements, or other conditions identified by the data. If it is determined that the data complies with the predefined rules, control proceeds to 505. If it is determined that the data does not comply with the predefined rules, control proceeds to 504.

At 504, a response is generated. According to an embodiment of the present invention, the response may involve initiating a modification to a smart camera or generating a notification or report.

At 505, a plurality of smart cameras are identified to be grouped in a cluster. According to an embodiment of the present invention, the smart cameras may be grouped automatically or manually based on the locations of the smart cameras, a subject or procedure the smart cameras are monitoring, or other criteria.

At 506, a map is generated for the cluster. According to an embodiment of the present invention, data generated from the smart cameras associated with the cluster is retrieved to form the map. A map may include image data, text data, a combination of image and text, and/or other type of data generated by the smart cameras.

At 507, the map is analyzed. According to an embodiment of the present invention, one or more polices may be applied to the map to determine whether the subject or event being monitored satisfies a desired goal. Alternatively, the map may be analyzed with respect to one or more other maps.

FIG. 5 is a flow chart illustrating a method according to an embodiment of the present invention. Some of the techniques illustrated in this figure may be performed sequentially, in parallel or in an order other than that which is described. It should be appreciated that not all of the techniques described are required to be performed, that additional techniques may be added, and that some of the illustrated techniques may be substituted with other techniques.

Embodiments of the present invention may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

In the foregoing specification embodiments of the invention has been described with reference to specific exemplary embodiments thereof. It will, however, be evident that various modifications and changes may be made thereto without departing from the broader spirit and scope of the embodiments of the invention. For example, although embodiments of the present invention are described with reference to smart cameras, it should be appreciated that other types of cameras may also be implemented. The specification and drawings are, accordingly, to be regarded in an illustrative rather than restrictive sense.

What is claimed is:

1. A method for managing a multiple vision system, comprising:
identifying a plurality of smart cameras to group in a cluster; and
generating a first map from data received from the smart cameras.

2. The method of claim 1, further comprising analyzing the data from the smart cameras with respect to predefined rules.

3. The method of claim 2, further comprising initiating a modification to the smart cameras.

4. The method of claim 2, further comprising generating a notification in response to an analysis.

5. The method of claim 1, further comprising:
apply one or more policies to the first map; and
generating a status report in response to an application.

6. The method of claim 1, further comprising comparing the first map with a second map.

7. The method of claim 6, further comprising generating a notification in response to a comparison.

8. The method of claim 1, further comprising:
assigning a camera identifier to each of the plurality of smart cameras; and
presenting the camera identifiers to a camera interface module to allow a single instance of the camera interface module to support the plurality of smart cameras.

9. The method of claim 8, wherein the camera identifier comprises a media access control (MAC) identifier.

10. The method of claim 8, wherein the camera identifier comprises an Internet Protocol (IP) address.

11. An article of manufacture comprising a machine accessible medium including sequences of instructions, the sequences of instructions including instructions which when executed cause the machine to perform:
identifying a plurality of smart cameras to group in a cluster; and
generating a first map from data received from the smart cameras.

12. The article of manufacture of claim 11, further comprising instructions which when executed cause the machine to perform analyzing the data from the smart cameras with respect to predefined rules.

13. The article of manufacture of claim 11, further comprising instructions which when executed cause the machine to perform:
apply one or more policies to the first map; and
generating a status report in response to an application.

14. The article of manufacture of claim 11, further comprising instructions which when executed cause the machine to perform comparing the first map with a second map.

15. The article of manufacture of claim 11, further comprising instructions which when executed cause the machine to perform:
assigning a camera identifier to each of the plurality of smart cameras; and
presenting the camera identifiers to a camera interface module to allow a single instance of the camera interface module to support the plurality of smart cameras.

16. A computer system, comprising:
a memory;
a plurality of smart cameras; and
a processor to implement a multi-camera interface server (MCIS) unit to identify a plurality of smart cameras to group in a cluster, and to generate a first map from data received from the plurality of smart cameras.

17. The computer system of claim 16, wherein the MCIS unit includes a data analysis unit to analyze the data from the smart cameras with respect to predefined rules.

18. The computer system of claim 16, wherein the MCIS unit includes a map analysis unit to apply one or more policies to the first map, and to generate a status report in response to an application.

19. The computer system of claim 16, further comprising a station controller unit to compare the first map with a second map.

20. The computer system of claim 16, wherein the MCIS unit includes a camera configuration module to assign a camera identifier to each of the plurality of smart cameras, and to present the camera identifiers to a camera interface module to allow a single instance of the camera interface module to support the plurality of smart cameras.
